(19) United States
(12) Patent Application Publication
(10) Pub. No.: US 2003/0019567 A1
(43) Pub. Date: Jan. 30, 2003

(54) Vacuum assisted resin transfer method for co-bonding composite laminate structures

(76) Inventors: Steven J. Burpo, St. Charles, MO (US); Terry A. Sewell, Ballwin, MO (US); John C. Waldrop III, St. Peters, MO (US)

Correspondence Address: HARNESS, DICKEY & PIERCE, P.L.C., P.O. BOX 828, BLOOMFIELD HILLS, MI, 48303, US

(21) Appl. No.: 09/915,886

(22) Filed: Jul. 26, 2001

(51) Int. Cl. B32B 31/00; B29C 65/00

(52) U.S. Cl. 156/245; 156/87; 156/286; 264/258; 264/101; 264/571

(57) ABSTRACT

A method for forming complexly shaped composite laminate assemblies. A pair of dry fiber preforms are placed on a tool with a thin film adhesive layer therebetween. A vacuum bag encloses the preforms and the adhesive layer. The preforms are heated to a temperature sufficient to cause the adhesive to become viscous and to wet several plys of each of the preforms. The preforms are then allowed to cool slightly before resin is infused via a vacuum source through each of the preforms to thoroughly wet each of the preforms. The resulting joint formed at the bond line of the two preforms is stronger than what would be formed simply by adhering two otherwise completely formed preforms together because the dry fiber preforms, in connection with the heating of the preforms, allow wetting of several plys of each of the preforms at the joint area, rather than just the surface ply of each preform.

### FIELD OF THE INVENTION

The present invention relates to a method for securing composite laminate structures, and more particularly to a method for bonding two or more composite laminate structures to produce an even stronger joint between the joined surfaces of the structures.

### BACKGROUND OF THE INVENTION

Vacuum assisted molding methods are well known in the art for forming resin-fiber composite structures. Traditionally, however, the formation of such structures has been limited to panels and other like-shaped structures. Complexly shaped structures, such as a portion of a skin and an associated stiffener, have heretofore been difficult, if not impossible, to produce from traditional composite molding systems and methods in a single molding step because such complex structures are difficult to “lay up”. By “lay up”, it is meant arranging a plurality of fiber plies (i.e., layers) into a single fiber pre-form. As such, the manufacture of various complexly shaped structures has typically involved forming two independent composite laminate structures through the well known vacuum molding process, and then securing the structures together via rivets or other like mechanical fasteners in a separate manufacturing step.

Various attempts have been made to bond two or more completely formed composite laminate structures together via a suitable adhesive. U.S. Pat. No. 4,786,383, assigned to The Boeing Company, discloses various methods for bonding two or more composite laminate structures together via an adhesive. While these methods have proven effective in bonding a wide variety of complexly shaped composite laminate structures, it would nevertheless be desirable to provide a system and method in which the bonding of two or more complexly shaped composite structures can be accomplished on a suitable tool, in a single manufacturing operation, using an otherwise conventional vacuum assisted resin transfer molding process. More specifically, it would be highly desirable to provide a system and method in which dry fiber preforms (i.e., multi-layer preforms that have not yet been preimpregnated with resin) can be placed on a suitable tool with the preforms precisely aligned in the desired orientation relative to one another, with an adhesive material placed at the desired bond line(s), and the bonding of the preforms together accomplished immediately prior to infusing the preforms with resin, and all with a single manufacturing operation. This would eliminate the added labor associated with subsequently taking the finished composite laminate component pieces and precisely aligning same, in a separate manufacturing step, prior to adhering the independent component pieces together. It is further expected that a system and method which accomplishes heating and flowing of the adhesive into the surfaces of two or more independent, dry fiber preforms, will produce even greater migration of the viscous adhesive into the plys of each of the preforms.

### SUMMARY OF THE INVENTION

The present invention is directed to a method for forming complexly shaped structures from two or more independent dry fiber preforms in a single manufacturing operation. The method involves the steps of taking the dry fiber preforms and assembling the preforms with adhesive material between those surfaces of the preforms that are to be bonded together. This is preferably accomplished with the preforms resting on a tool of a conventional vacuum assisted resin transfer molding apparatus. The preforms are precisely aligned relative to one another and one or more alignment tools are used to maintain the preforms in the desired alignment. An airtight structure, for example, a vacuum bag, is then placed over the entire structure. The vacuum bag has at least one opening which is in communication with a reservoir filled with resin and at least one opening which is in communication with a vacuum generating source.

In the preferred embodiments, the adhesive comprises a thin film layer of adhesive which is placed between each of the surfaces of the two preforms being bonded together. The entire assembly is heated to a temperature sufficient to cause the adhesive to become viscous and to migrate (i.e., flow) into the plys of each of the preforms. A vacuum force is generated at this time which further assists in causing the viscous adhesive to migrate and thoroughly “wet” several plys of each of the preforms at those areas where the adhesive has been placed. When it is determined that satisfactory wetting of the dry fiber preforms with the adhesive has occurred, resin from the resin reservoir is admitted into the airtight enclosure and drawn through each of the preforms to thoroughly wet each of the preforms. The resin substantially fills the microscopic pockets and interstices around each fiber in those plys which the adhesive has wet. This strengthens the bond line at those areas that are being joined by the adhesive.

The entire assembly is then allowed to cure before being removed from the tool. Once removed, the two preforms form a rigid, single piece composite laminate structure. Advantageously, the bonding of the independent dry fiber preforms and the subsequent infusion of resin into each of the preforms is accomplished in a single manufacturing operation. The joint produced at the bond line(s) of the preforms is enhanced due to the increased migration of the viscous adhesive into the plys of each of the preforms at those areas where bonding has taken place.

Further areas of applicability of the present invention will become apparent from the detailed description provided hereinafter. It should be understood that the detailed description and specific examples, while indicating the preferred embodiment of the invention, are intended for purposes of illustration only and are not intended to limit the scope of the invention.

### BRIEF DESCRIPTION OF THE DRAWINGS

The present invention will become more fully understood from the detailed description and the accompanying drawings, wherein:

FIG. 1 is a simplified view of a portion of the tool for preforming the method of the present invention and showing two independent dry fiber preforms in contact with one another ready to be bonded together;

FIG. 2 is an enlarged view of one area of the two dry fiber preforms of FIG. 1 illustrating the thin film resin layer just prior to having migrated into the plys of each of the preforms and resin being infused into each of the preforms;

FIG. 3 is a view of the assembly shown in FIG. 2 but after the adhesive has flowed into the plys of each of the fiber preforms, and also after the resin has thoroughly wetted each of the preforms;

FIG. 4 is a photomicrograph of the bond line between a pair of dry fiber preforms after the adhesive has flowed into several plys of each preform; and

FIG. 5 is a photomicrograph of a pair of fiber preforms after the adhesive has flowed into several plys of each preform and after resin has been infused into each preform to thoroughly wet the fibers of each preform.

### DETAILED DESCRIPTION OF THE PREFERRED EMBODIMENTS

The following description of the preferred embodiment(s) is merely exemplary in nature and is in no way intended to limit the invention, its application, or uses.

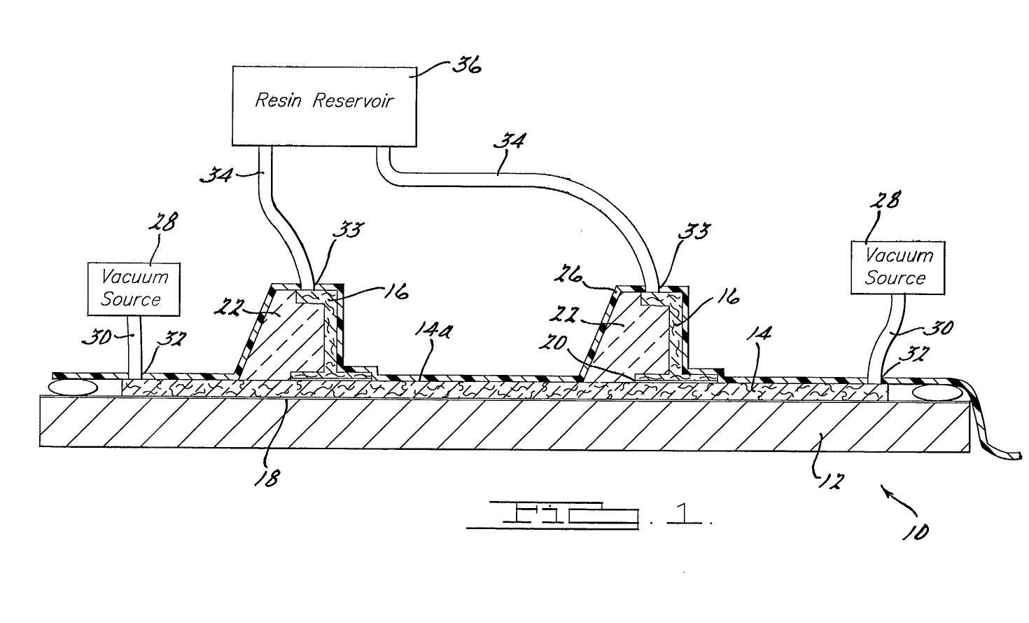

Referring to FIG. 1, there is shown a portion of a tool 10 used for implementing a preferred method of vacuum assisted resin transfer co-bonding in accordance with the present invention. The tool 10 is a conventional tool used for preforming vacuum assisted resin transfer molding, and is therefore well known in the art. The tool 10 generally comprises a relatively large (i.e. typically one (25.4 mm) inch thick) aluminum plate 12 upon which the molding operation takes place. A first dry fiber preform 14 and a second dry fiber preform 16 are placed in contact with one another in the desired orientation. It is strongly preferred that dry fiber preforms be used since this will ensure maximum strength at the joint between the two preforms 14 and 16 when the molding operation is completed. Each of the dry fiber preforms 14 and 16 comprise preformed fiber layups, typically comprised of fiberglass or carbon cloth. In this example, the dry fiber preform 14 will eventually comprise a section of skin of an aircraft fuselage while dry fiber preform 16 comprises a stiffener. However, it will be understood that the method of the present invention is not limited to the securing of any two particular shapes of preforms, but can be adapted for use with a wide variety of differently shaped preforms to form complexly shaped assemblies such as C-shaped composite laminate assemblies, Z-shaped assemblies, and so forth.

Such preforms are also typically formed from a plurality of plys (i.e., layers) of fibrous material, and typically with adjacent layers being disposed so that the fibers extend perpendicularly to each other. Thus, it can be said that the fibers are directed along the X and Y axes of the surface of the material but that no fibers extend in the Z direction. Thus, when two opposing surfaces are bonded together with adhesive, the adhesive essentially forms the only means by which the two surfaces are held together. Thus, the greater the migration of adhesive into each of the plys of the surfaces being bonded together, the greater the joint strength becomes.

With further reference to FIG. 1, the dry fiber preform 14 which is intended to rest on the tool 12 is initially placed on a thin release sheet 18. This sheet is a thin layer, typically 1-2 mills (0.0254 mm-0.0508 mm) thick, fluoroelastomer material or Teflon® which allows the preform 14 to be easily removed from the surface of the tool 12 after the molding operation is completed. A thin film adhesive layer 20, typically between about 15-20 (0.381 mm-0.508 mm) mills in thickness, is placed on an upper surface 14a of the preform 14 and sandwiched inbetween those surfaces which are to be bonded together. The adhesive layer 20 is essentially a cloth impregnated with adhesive and commercially available from a number of sources.

With further reference to FIG. 1, an alignment member 22 is used to hold each dry fiber preform 16 in a precise orientation relative to the preform 14 during the molding operation. The alignment member 22 typically comprises a washable mandrel comprised of a solid block of foam or silicone which can be easily removed from contact with the preforms 14 and 16 after the molding operation is completed. The alignment tool 22 and the preforms 14 and 16 with the adhesive layer 20 therebetween are enclosed within an airtight structure, such as a vacuum bag 26. The vacuum bag 26 is coupled to one or more vacuum sources 28 via one or more sections of conduits or tubing 30 in communication with one or more openings 32 in the vacuum bag 26. While two vacuum sources 28 and two sections of tubing 30 are illustrated in FIG. 1, it will be appreciated that the method of the present invention can be preformed with a single vacuum source and a single vacuum tube, but that the construction of the composite laminate assembly being formed may dictate that two or more such vacuum sources may be required.

The vacuum bag 26 also includes at least one opening, and in the drawing of FIG. 1 a pair of openings 33, which are in communication with a corresponding pair of lengths of conduit or tubing 34 leading to a resin reservoir 36. Tubing lengths 34 allow resin to be drawn in by the vacuum created by vacuum sources 28 from the resin reservoir 36 into the interior area defined by the vacuum bag 26. Again, however, depending upon the overall shape of the composite laminate structure being formed, a single resin supply line 34 and a single point of entry 32 in the vacuum bag 26 may be sufficient to adequately supply the needed amount of resin to preform the molding process.

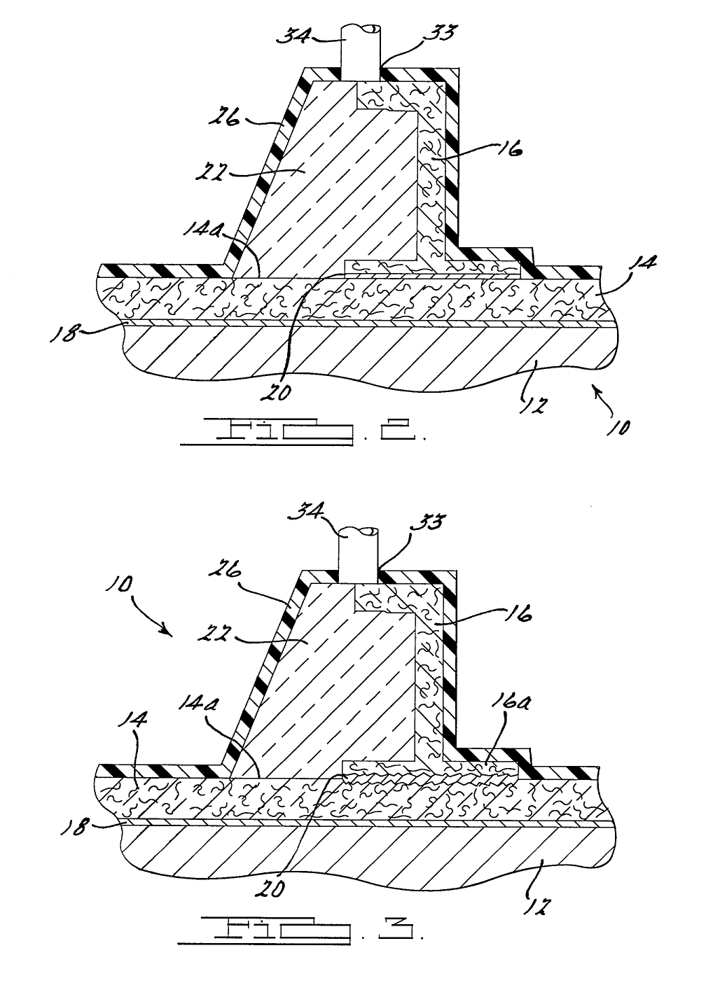

Referring to FIG. 2, once the dry fiber preforms 14 and 16, the adhesive layer 20 and the alignment member 24 are enclosed within the vacuum bag 26, the entire assembly is heated to a temperature preferably between about 150° F. (66° C.) and 300° F. (149° C.), and more preferably to about 250° F. (121° C.) for a time period in the range of between about 15 minutes to 60 minutes. However, these temperatures and time durations are exemplary only, and the specific temperature and time duration required will depend in large part on the specific type of resin being used, as well as the specific configuration of the part being formed.

The heating phase causes the adhesive layer 20 to become viscous and to migrate (i.e., flow) into several plys of each of the preforms 14 and 16. By heating the preforms 14 and 16 along with the adhesive, this also has the beneficial effect of removing any residual moisture that may be contained in the preforms 14 and 16 which might impede the flow of the adhesive 20 into the plys thereof. The use of dry fiber preforms rather than prepregs is important because the adhesive is able to flow more easily into several plys of each of the preforms 14 and 16. Thus, wetting of more than just the surface ply of each preform 14 and 16 occurs. This is in contrast to methods which involve heating already completely resin cured preforms with an adhesive layer placed between surfaces to be joined, which typically only allows the outermost ply of each preform to be wetted with the adhesive. With the method of the present invention, the viscous adhesive flows and substantially fills the interstices and microscopic voids around the individual fibers of the first several plys of each preform 14 and 16.

During the above-described initial phase of heating each of the preforms 14 and 16 and the adhesive layer 20, a vacuum may be generated by the vacuum sources 28 to further assist in drawing the viscous adhesive 20 into the plys of each of the preforms 14 and 16. However, the use of dry fiber preforms and the heating of the preforms together with the adhesive layer 20 is sufficient to cause wetting of several plys of the preforms 14 and 16 at the eventual bond areas.

After the adhesive 20 has fully wetted the plys of each of the dry fiber preforms 14 and 16, the preforms are allowed to cool down to a temperature between about room temperature, i.e., about 70° F. (21° C.) and 200° F. (93° C.), and more preferably about 150° F. (65° C.). Once the preforms 14 and 16 have cooled to this temperature, the vacuum sources 28 are turned on, if they haven't already been operating during the prior heating phase, and suitable valves (not shown) in the resin supply conduits 34 allow resin to flow from the resin reservoir 36 through the openings 33 in the vacuum bag 26 and into each of the preforms 14 and 16. The resin thoroughly wets all of the plys of each of the preforms 14 and 16 and further flows into the small interstices and voids around the fibers in those plys which have previously been wetted by the adhesive 20. By this time the adhesive 20 will be partially cured (referred to in the art typically as “B-staged”) and only a small degree of little additional flow of the adhesive will occur until the resin viscosity becomes too high for flow to continue. Thus, the adhesive 20 will not be pulled away from the bond line at the surfaces of the preforms 14 and 16 being joined. By flowing into the interstices, pockets and voids around those fibers which the adhesive 20 has not occupied, the resin “backfills” these areas to further enhance the strength of the joint formed between the preforms 14 and 16. The flow of the resin is indicated by arrows 38 in FIG. 2.

The complete wetting of each of the preforms 14 and 16 with resin can be visually detected by an operator if the vacuum bag 26 comprises a translucent vacuum bag. If not, thorough wetting can be assumed as soon as the resin begins to be drawn out of the preforms 14 and 16 and into each of the tubing sections 30 and 32 (FIG. 1). At this point, the vacuum sources 28 are turned off and the flow of resin in each of the resin supply lines 34 is interrupted through the use of one or more conventional valves. It will be appreciated that some adjustment of the vacuum lines 30 and resin supply lines 34 can be performed to help any air from the preform 16. Referring to FIG. 3, at this point it can be seen that the thin film adhesive layer 20 has essentially disappeared, having essentially flowed into several plys of the preform 14 and several plys of portion 16a of the preform 16. The temperature of the preforms 14 and 16 is then raised to preferably between about 200° F. (93° C.) and 400° F. (204° C.) depending on the resin system, and more preferably about 350° (176° C.). Again, however, it will be appreciated that these temperatures will depend on the resin being used.

The preforms 14 and 16 are then held at this temperature for preferably between about four hours-eight hours, depending on the resin system, and more preferably for about six hours, depending on the resin being used. This fully cures the adhesive 20 and the resin in each of the preforms 14 and 16 to form a single composite laminate structure. The joint(s) at the surfaces of the preforms 14 and 16 which have been bonded together have exhibited a significant improvement in “pull away” strength of about 25%-30% over those composite laminate structures where adhesive has been used to bond otherwise completely or partially cured preforms into a single structure. In strength testing, a joint constructed in accordance with the method of the present invention showed an improvement in the maximum average shear load that could be applied before separation of the joined components began to occur from 186 lb./in. to 264 lb./in. Once the preforms 14 and 16 have been fully cured, the vacuum bag 26 is removed, the alignment members 24 are separated from the preforms 14 and 16, and the preform 14 is removed from the release layer 18.

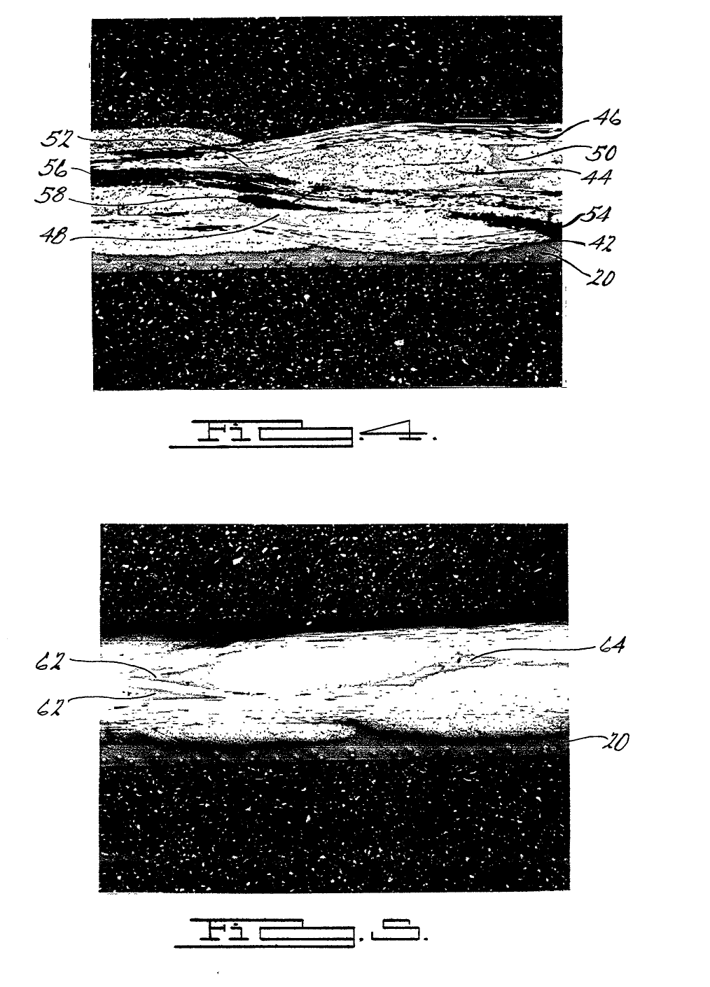

With brief reference to FIGS. 4 and 5, the photomicrograph of FIG. 4 represents a magnification of 25× of a typical fiber preform (either preform 14 or 16) after the preform has been wetted with the adhesive 20 during the first stage of the above-described method (i.e., before resin has been infused into the preform). The adhesive layer 20 extends along the length of the preform while areas 42, 44 and 46 represent fibers forming separate plys of the preform. It can be seen that portions of adhesive 20 have flowed into areas 48, 50 and 52 inbetween the fibers 42, 44 and 46. Areas 54, 56 and 58 represents areas which are void of both adhesive 20 and resin.

Turning to FIG. 5, a section of a fiber preform (either 14 or 16) is shown after the resin and adhesive 20 have fully wet the preform. The adhesive 20 can be seen to occupy areas 60, 62 and 64, and the resin, which is the color white in the photomicrographs of FIGS. 4 and 5, has essentially saturated and back filled those voids, pockets and interstices which were not previously filled by the adhesive. This thorough wetting of those areas with the resin that were not previously wetted with the adhesive 20 serves to form an even stronger joint when the preforms are fully cured.

The method of the present invention provides significant manufacturing advantages over previously developed methods which rely on using fully cured preforms to begin the adhesive bonding process. The dry preforms 14 and 16 and the adhesive layer 20 can be set up in one step within the vacuum bag 26 and then formed in a single molding operation. This saves significant labor and time over those methods which require the preforms to be partially or fully cured with resin before being bonded together. The present invention, in some applications, may also provide for better locational control of features, less final trim cleanup work and better part definition. The method of the present invention also requires fewer tools during the infusion step.

By using dry fiber preforms 14 and 16, the preforms themselves do not need to be stored in a carefully temperature controlled environment, as would typically be the case with B-staged preforms. The use of dry fiber preforms rather than B-staged preforms also means that limitations on the time during which the preforms can be stored is not a consideration, as would be the case with B-staged preforms. B-staged preforms must typically be used within a relatively short time period (typically one month or less) from the time that the B-staging has occurred. The method of the present invention further involves less handling and human contact with the resin by workers because of the use of dry fiber preforms rather than B-staged or fully wetted preforms.

The method of the present invention may be used with, or may include, apparatuses and/or teachings described in U.S. Pat. Nos. 4,786,343 to Hertzberg; 4,902,215 to Seemann III; 4,942,013 to Palmer et al; 5,939,013 to Han; and U.S. application Ser. No. 09/731,945, filed Dec. 07, 2000 (assigned to The Boeing Co.), all of which are hereby incorporated by reference.

Those skilled in the art can now appreciate from the foregoing description that the broad teachings of the present invention can be implemented in a variety of forms. Therefore, while this invention has been described in connection with particular examples thereof, the true scope of the invention should not be so limited since other modifications will become apparent to the skilled practitioner upon a study of the drawings, specification and following claims.

What is claimed is:

1. A method for forming a composite laminate structure comprising:
a) providing a first dry fiber preform;
b) placing a thin film adhesive material against a surface of said first dry fiber preform;
c) placing a second dry fiber preform against said adhesive material to thereby sandwich said thin film adhesive material between said dry fiber preforms and thereby form a composite laminate assembly, each of said dry fiber preforms having a plurality of layers of fiber material;
d) placing said composite laminate assembly within an airtight enclosure;
e) heating said thin film adhesive material and said dry fiber preforms to a temperature sufficient to cause said thin film adhesive material to become viscous;
f) causing said viscous adhesive to flow into a subplurality of layers of each of said dry fiber preforms to at least substantially saturate a subplurality of said layers of each of said dry fiber preforms; and
g) after said subplurality of said layers of said dry fiber preforms are substantially saturated with said viscous adhesive, then infusing a resin into each of said dry fiber preforms to thoroughly wet said dry fiber preforms.

2. The method of claim 1, further comprising the step of curing said dry fiber preforms, whereupon said composite laminate assembly is formed into said composite laminate structure.

3. The method of claim 2, wherein said step of curing comprises heating said composite laminate assembly to a temperature between about 200 degrees Fahrenheit and 400 degrees Fahrenheit for a predetermined period of time.

4. The method of claim 1, wherein:
step d) comprises placing said dry fiber preforms within a vacuum bag and;
step f) comprises applying a vacuum to said vacuum bag to cause said viscous adhesive to flow into said subplurality of layers of each of said dry fiber preforms.

5. The method of claim 1, wherein step e) comprises heating said dry fiber preforms to a temperature of between about 150 degrees Fahrenheit and 300 degrees Fahrenheit.

6. The method of claim 5, wherein step g) comprises the step of allowing said dry fiber preforms to cool to a temperature of between about 70 degrees Fahrenheit and 200 degrees Fahrenheit before beginning to infuse said resin into said preforms.

7. A method for forming a composite laminate structure comprising:
providing a first dry fiber preform;
placing a layer of thin film adhesive against a surface of said first dry fiber preform;
placing a second dry fiber preform against said thin film adhesive layer to thereby sandwich said thin film adhesive layer between said dry fiber preforms and thereby form a composite laminate assembly, each of said dry fiber preforms having a plurality of layers of fiber material;
placing said composite laminate assembly within a vacuum bag;
heating said composite laminate assembly to a predetermined temperature sufficient to cause said thin film adhesive layer to become viscous and to flow into a subplurality of said layers of said fiber material of each of said dry fiber preforms, to thereby at least substantially saturate said subplurality of layers;
after said subplurality of said layers of said fiber material are substantially saturated with said viscous adhesive, then infusing a resin into said dry fiber preforms and using said vacuum to draw said resin through said dry fiber preforms to thoroughly wet said dry fiber preforms; and
curing said composite laminate assembly to form said composite laminate structure.

8. The method of claim 7, wherein said composite laminate assembly is heated to a temperature between about 150 degrees Fahrenheit and 300 degrees Fahrenheit to cause said adhesive thin film layer to become viscous.

9. The method of claim 7, wherein said composite laminate assembly is heated to a temperature of approximately 250 degrees Fahrenheit to cause said adhesive to become viscous.

10. The method of claim 7, wherein said composite laminate assembly is allowed to cool to a temperature below said predetermined temperature that caused said adhesive thin film layer to become viscous after said adhesive has at least substantially saturated said subplurality of layers of said dry fiber preforms, before infusing said resin into said dry fiber preforms.

11. The method of claim 10, wherein said composite laminate assembly is heated to a temperature of between about 150 degrees Fahrenheit and 300 degrees Fahrenheit to cause said adhesive thin film adhesive layer to become viscous; and
wherein said dry fiber preforms are allowed to cool to a temperature of between about 70 degrees Fahrenheit and 200 degrees Fahrenheit after said viscous adhesive saturates said subplurality of layers of said dry fiber preforms.

12. The method of claim 7, wherein said curing step is accomplished by heating said dry fiber preforms to a temperature of between about 200 degrees Fahrenheit and 400 degrees Fahrenheit.

13. The method of claim 7, wherein said curing step is accomplished by heating said dry fiber preforms to a temperature of approximately 350 degrees Fahrenheit for a predetermined length of time.

14. The method of claim 12, wherein said predetermined length of time comprises a duration of between about fours hours and eight hours.

15. A method for forming at least a pair of independent dry fiber preforms into a composite laminate structure, wherein each of said dry fiber preforms includes a plurality of layers of fiber material, the method comprising the steps of:
disposing a thin film adhesive layer between opposing surfaces of said dry fiber preforms such that said adhesive layer is sandwiched between said dry fiber preforms;
placing said dry fiber preforms with said adhesive layer therebetween within a vacuum enclosure;
heating said dry fiber preforms and said adhesive layer to a first temperature sufficient to cause said adhesive layer to become viscous;
applying a vacuum to said vacuum enclosure to cause said viscous adhesive to flow into a subplurality of said plurality of layers of said fiber material of each of said dry fiber preforms to substantially saturate said subplurality of said plurality of layers;
waiting a period of time for said dry fiber preforms to cool down to a second temperature;
once said dry fiber preforms reach said second temperature, using said vacuum to draw resin from a resin reservoir in communication with said vacuum enclosure through said dry fiber preforms to thoroughly wet said dry fiber preforms; and
after said dry fiber preforms have been thoroughly wetted by said resin, further heating said dry fiber preforms to a third temperature greater than said first temperature to cure said preforms, whereupon curing said dry fiber preforms are bonded to one another to form said composite laminate assembly.

16. The method of claim 15, wherein said first temperature comprises a temperature within the range of about 150 degrees Fahrenheit to 300 degrees Fahrenheit.

17. The method of claim 15, wherein said second temperature comprises a temperature within the range of about 70 degrees Fahrenheit to 200 degrees Fahrenheit.

18. The method of claim 15, wherein said third temperature comprises a temperature within the range of about 200 degrees Fahrenheit to 400 degrees Fahrenheit.

19. A joint comprising:
a first fiber preform having a plurality of plys;
a second fiber preform having a plurality of plys;
an adhesive layer placed between opposing surfaces of the first and second fiber preforms prior to the preforms being infused with a resin; and
wherein said joint is formed by:
first heating said adhesive and said preforms prior to infusing resin in said preforms such that said adhesive migrates into a plurality of plys of each of said preforms;
allowing said preforms and said adhesive to cool for a predetermined period of time; and
infusing resin into each of said preforms to substantially saturate said preforms with resin, said resin substantially backfilling interstices and voids in areas of said plys of said preforms where said adhesive has not saturated.
